(19) United States
(12) Patent Application Publication
(10) Pub. No.: US 2023/0325781 A1
(43) Pub. Date: Oct. 12, 2023

(54) AUTOMATED COMMUNICATIONS TO INTRODUCE CONTACTS IN NETWORK MANAGER SOFTWARE APPLICATION

(71) Applicant: UPHABIT INC., Toronto (CA)

(72) Inventor: Neil WAINWRIGHT, Toronto (CA)

(21) Appl. No.: 18/025,482

(22) PCT Filed: Sep. 8, 2021
(86) PCT No.: PCT/CA2021/000084

§ 371 Date: Mar. 9, 2023

Related U.S. Application Data
(60) Provisional application No. 63/076,367, filed on Sep. 9, 2020.
(60) Provisional application No. 63/076,350, filed on Sep. 9, 2020.

(51) Int. Cl. G06Q 10/107; H04L 51/48

(52) U.S. Cl. CPC G06Q 10/107; H04L 51/48

(57) ABSTRACT

A method implemented by executing a software application on a computer or mobile device includes the steps of receiving a plurality of contacts selected for a proposed introduction; displaying an introduction message screen configured for composing an introduction message to the contacts to make the introduction, wherein the introduction message screen includes Tillable fields for each of the contacts and a message text field; and sending an introduction message to the contacts that includes inputs to the tillable fields and text entered in the message text field. The method may include sending opt-in messages to the recipients to gain prior permission to send the introduction message, and sending a survey to the recipients after the introduction message is sent. The software application may be configured to scan user emails for introductory terms and phrases and suggest potential introductions made outside the software application for addition to the software application.

### FIELD OF THE DISCLOSURE

This disclosure relates to a software application and methods for generating and tracking introductions among contacts.

### BACKGROUND OF THE DISCLOSURE

Many professionals rely on growing their network of contacts for mentorship, client development, and new opportunities. While beneficial, it can be time-consuming to repeatedly make introductions and monitor those introductions for success and completion. Even with a software application for making and managing introductions, a user needs to manually note any introductions made outside of the application by other means, for example by email messages.

Therefore, improved methods and systems are needed.

### SUMMARY OF THE DISCLOSURE

The disclosure describes a Software application and related method for creating and tracking introductions between and among contacts in a user's network of contacts. The method, which may be implemented by executing the software application on a system such as a computer or mobile device, may generally comprise the steps of receiving, using a processor, a plurality of contacts selected for a proposed introduction; displaying an introduction message screen, using the processor, wherein the introduction message screen is configured for composing an introduction message to be sent to the plurality of contacts to make the introduction, wherein the introduction message screen includes fillable fields for each of the plurality of contacts and a message text field, wherein the fillable fields are filled using the processor, and the message text field receives text entries entered by a user; and sending an introduction message, using the processor, to the plurality of contacts, wherein the message includes inputs to the fillable fields and text entered in the message text field.

In a further aspect of the present disclosure, the software application may be configured to execute a method for finding potential introductions (i.e. “suggested” introductions) made by the user outside of the software application, and enabling the user to add chosen suggested introductions to a database of introductions accessed by the software application for tracking. The method of the further aspect may generally comprise the steps of scanning emails of the user, using a processor, to find introductory terms and phrases; determining, using the processor, that one of the emails is a potential introduction email based on introductory phrases; and displaying, using the processor, a screen to the user prompting the user to confirm that the potential introduction email is an actual introduction email. If the user confirms the email the potential introduction email is an actual introduction email, an introduction based on the email is added to the user's database of introductions managed by the software application.

The software application and methods of the present disclosure enhance and facilitate making introductions by applying automation functions including populating message templates with contact names, introductory text, and social media profiles, duplicating and editing an introduction message that was already made, requesting permissions to make an introduction, and creating reminders to follow up and to request survey feedback. With regard to scanning emails to find potential introductions, the software application may be configured to allow the user to add and delete introductory terms and phrases to tailor the search function as the user sees fit.

### DESCRIPTION OF THE DRAWINGS

For a fuller understanding of the nature and objects of the disclosure, reference should be made to the following detailed description taken in conjunction with the accompanying drawings, in which:

FIG. 1 is a flow diagram generally illustrating a process for creating and tracking new introductions in an application, and adding suggested introductions to the application for tracking where the suggested introduction was initiated in another application, in accordance with an embodiment of the present disclosure;

FIG. 2 is flow diagram illustrating a process for selecting and approving contacts for a new introduction in an aspect of the embodiment shown in FIG. 1;

FIG. 3 is flow diagram illustrating a process for creating an introduction message to be sent to contacts being introduced to one another, and soliciting feedback surveys from the introduction contacts, in an aspect of the embodiment shown in FIG. 1;

FIG. 4 is an exemplary screenshot of an introductions screen of the application;

FIG. 5 is an exemplary screenshot of an opt-in request screen of the application;

FIG. 6 is another exemplary screenshot of an introductions screen of the application;

FIG. 7 is another exemplary screenshot of an introductions screen of the application;

FIG. 8 is an exemplary screenshot a new introduction message screen of the application;

FIG. 9 is an exemplary screenshot of an introduction detail screen of the application;

FIG. 10 is an exemplary screenshot of a reminder scheduling screen of the application;

FIG. 11 is an exemplary screenshot of a survey screen of the application;

FIG. 12 is flow diagram illustrating a process for finding a suggested introduction made outside the application and adding the suggested introduction to the application for tracking in another aspect of the embodiment shown in FIG. 1;

FIG. 13 is an exemplary screenshot of an introductions screen of the application displaying a “Track received introductions” card according to an embodiment of the present disclosure;

FIG. 14 is another exemplary screenshot of a track introductions screen of the application according to an embodiment of the present disclosure;

FIG. 15 is a block diagram of a mobile device configured to execute an application according to an embodiment of the present disclosure; and

FIG. 16 is a block diagram of a computer system configured to execute an application according to an embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

Embodiments disclosed herein enable a user to create and manage an introduction flow for any number of selected contacts. The method and system disclosed herein may include introduction requests, integrated reminders, feedback surveys, and suggested introductions. This allows a user to thoughtfully create and track introductions between and among contacts from beginning to end.

In a first aspect of the disclosure, a process is provided for introducing two or more contacts in a user's contact list of an application (e.g. a mobile application or a web application) and tracking the outcome of the introduction. For sake of describing the process by example, and without limiting the process, the present disclosure references a mobile application named “UpHabit” that has a contact list stored by a user of the UpHabit application.

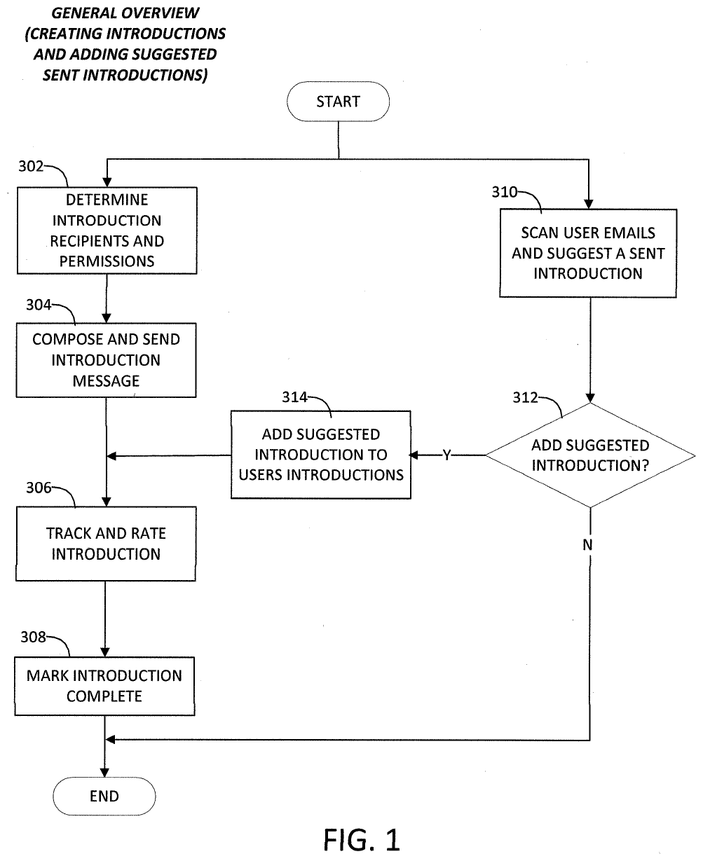

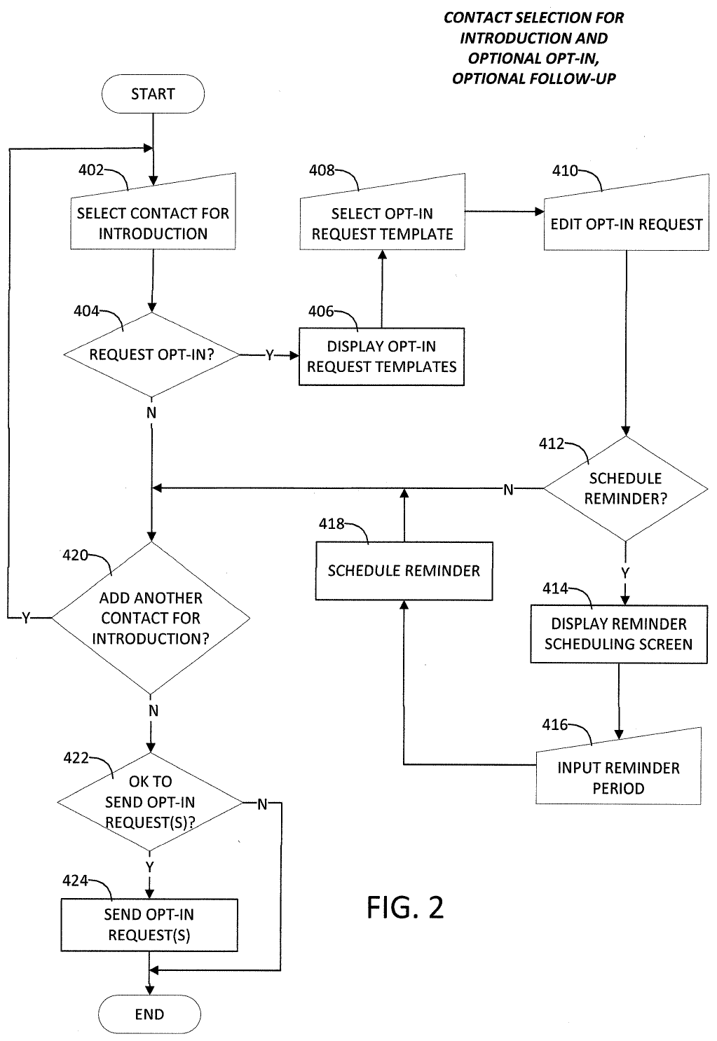

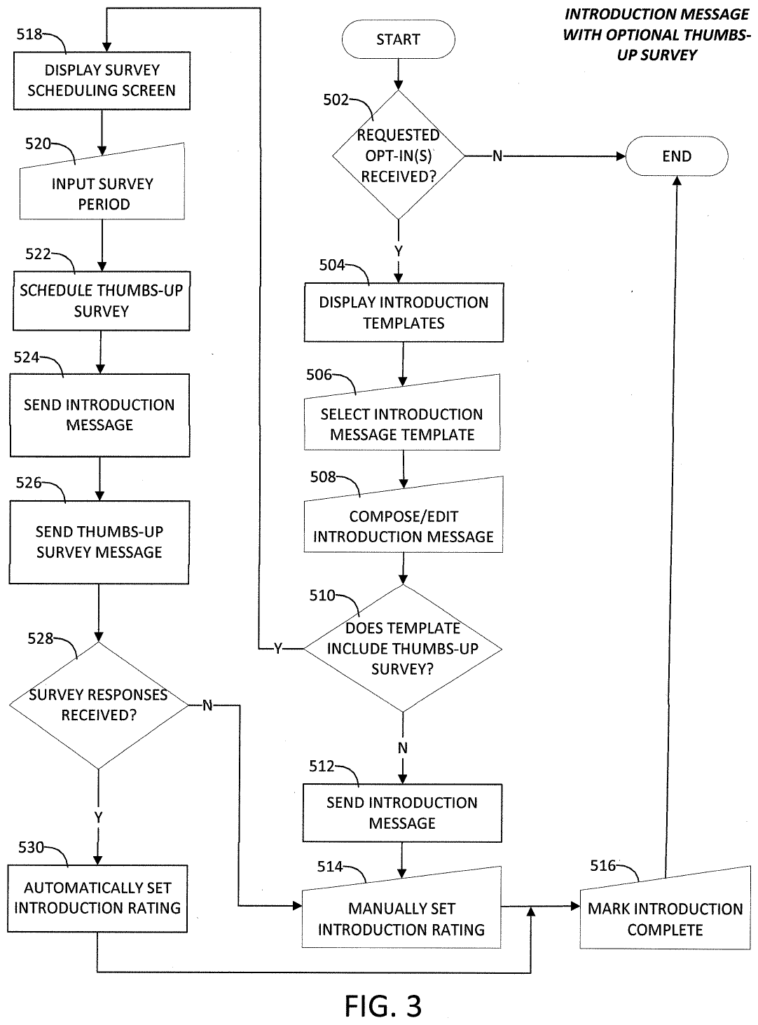

FIGS. 1-11 are referenced to describe a process for creating and tracking introductions according to an embodiment of the present disclosure. FIG. 1 provides a general overview for creating a new introduction. As indicated by block 302 in FIG. 1, the UpHabit application may be configured to enable a user to determine introduction recipients and opt-in permissions associated with the introduction recipients. The UpHabit application may also be configured to enable a user to compose and send an introduction message to each of the introduction recipients in accordance with block 304. Subsequently, the UpHabit application enables the user to track the introduction and receive feedback from the introduction recipients to rate the introduction, as shown in block 306, and to mark the introduction as completed, as shown in block 308. Further details regarding block 302 are illustrated by the flow diagram of FIG. 2. Further details regarding blocks 304, 306, and 308 are illustrated by the flow diagram of FIG. 3.

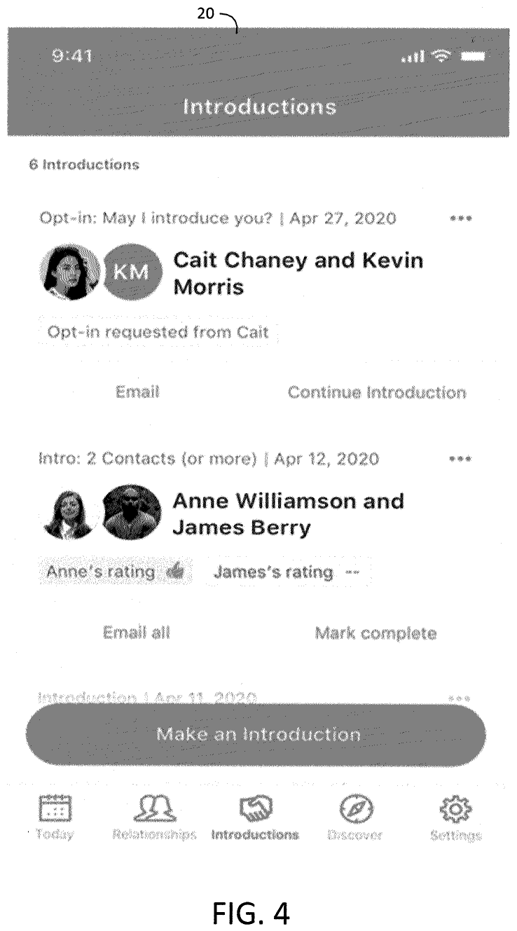

Referring now to FIG. 2, the UpHabit application is configured to receive a contact selection, represented by block 402, which may be made by the user from the user's contact list the UpHabit application or from another contact list accessible by the UpHabit application. The user's contact list for a mobile device inbox and/or contacts in social media platforms may be accessed. Thus, the contact list may include a link to a social networking profile (e.g., a Linkedin profile) for the contact. The UpHabit application may be configured to display an introductions screen to a user after the user navigates to this function. FIG. 4 shows an example of an introductions screen 20 in accordance with an embodiment of the UpHabit application. The introduction screen 20 may be configured for a proposed introduction between two or more contacts of the user, such as those in a contact list in the UpHabit application, mobile device contact list, and/or other contact list.

An opt-in request: may be sent to a selected recipient prior to sending an introduction message to the selected recipient. The opt-in request functionality in the UpHabit application allows the user to automatically request permission from one or more intended introduction recipients to receive an introduction. By requiring one or more introduction recipients to opt-in, the user will have improved the chances that each recipient who has opted-in will respond after the introduction is made because the recipient has pre-consented to the introduction. For example, in an introduction between two people, the user may create a “double opt-in introduction,” improving the likelihood that both parties will respond after the introduction is made. When permission is granted by the recipient, the user is able to follow through with the introduction. Moreover, the opt-in feature helps prevent inadvertent introductions and introductions that one recipient may not be interested in.

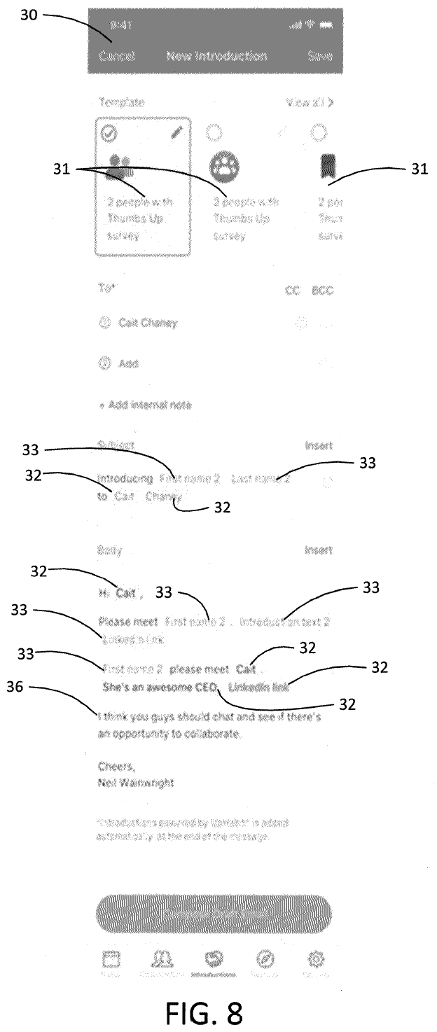

For example, the UpHabit application may be configured to prompt the user for input indicating whether or not an opt-in request is desired for each selected recipient. If an opt-in request is desired for the selected recipient, decision block 404 directs flow to block 406. Pursuant to block 406, the UpHabit application may be configured to display various opt-in request templates. For example, as shown in FIG. 8, the UpHabit application may be configured to display a new introduction message screen 30 providing a plurality of templates 31 for opt-in requests and other types of messages to be sent by the UpHabit application. A user may select any one of the opt-in request templates in accordance with block 408. For example, an opt-in request template for a two-person introduction may be configured to allow the user to select one contact to “Send message to” and one other contact that the user is “Asking about an introduction to.” The UpHabit application may be configured to prefill variable fields 32, 33 of the opt-in request with contact information for the selected recipients (e.g., contact name, respective introductory text, and respective LinkedIn profile or other link/profile). The UpHabit application may further be configured to allow the user to edit the template-based opt-in request in a message text field 36 to compose a final opt-in request, as shown in block 410, that may be sent to the selected recipient. In addition to tillable fields of variable information mentioned above, the opt-in request template may ask the user to fill a new field: reason for introduction. Text for this field may be entered by the user during opt-in request composition, and may be automatically inserted into its placeholder field.

The UpHabit application may be configured to prompt the user for input indicating whether or not a follow-up reminder to the opt-in request should be scheduled for the selected recipient. If a follow-up reminder is desired for the selected recipient, decision block 412 directs flow to block 414 and a reminder scheduling screen, such as reminder scheduling screen 40 shown in FRI. 10, may be displayed to the user. Reminder scheduling screen 40 enables the user to schedule a one-time automatic reminder to follow up with the opt-in request recipient a variable number of days after the opt-in request is sent, as represented by block 416. After the reminder is scheduled in block 418, flow proceeds to decision block 420. In accordance with decision block 420, the UpHabit application may be configured to allow the user to add further contacts to the introduction, and for each added contact, determine whether or not an opt-in request should be sent and a reminder scheduled, as described above. As may be understood, the user may include an opt-in request for all of the selected introduction recipients, some of the selected introduction recipients, or none of the selected introduction recipients. The UpHabit application is configured such that if an opt-in request is included for a given recipient, the introduction message will not be sent unless the recipient has given consent by sending a positive response to the opt-in request.

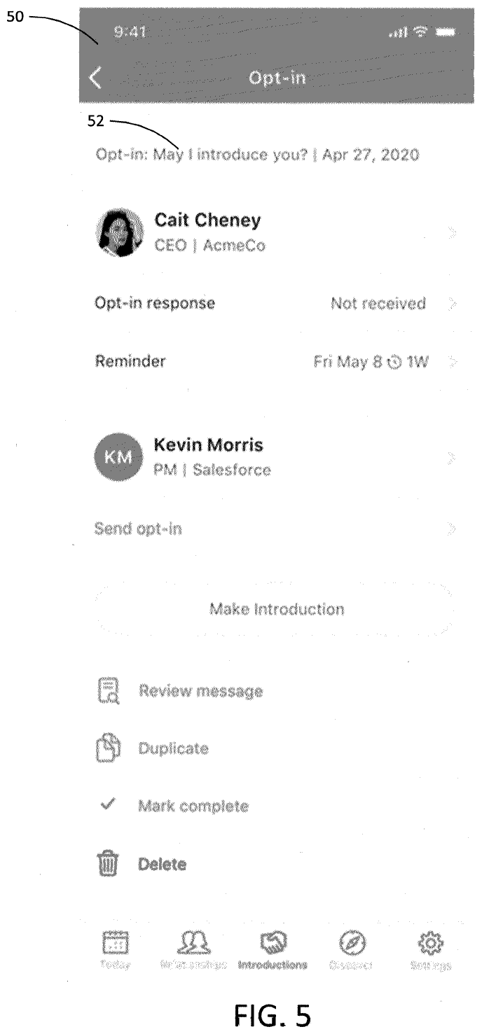

If, in accordance with decision block 420, the user is done entering selected contacts to the new introduction, then the UpHabit application may be configured to prompt the user for input indicating final approval to send the opt-in request(s) to the designated recipient(s). If final approval is given by the user, then decision block 422 directs flow to block 424, pursuant to which the opt-in request(s) are sent. The UpHabit application may be configured to send each opt-in request to the selected recipient as an email message. FIG. 5 shows an exemplary opt-in request screen 50 of the UpHabit application, wherein an example of an opt-in request is identified by reference numeral 52.

Reference is now made to FIG. 3 for describing how an actual introduction message may be composed and sent to the selected recipients in accordance with an embodiment of the present disclosure. The UpHabit application may be configured to check for receipt of all requested opt-in(s) from the selected recipients, and to only proceed with creating an introduction message if all applicable recipients have opted-in by replying positively to the opt-in request. This initial requirement is represented by decision block 502. Alternatively, the UpHabit application may be configured to permit creation of an introduction message as described in greater detail below, but defer sending the introduction message until all recipients have opted-in by replying positively to the opt-in request.

In an embodiment of the UpHabit application, composing an introduction message is similar to composing an opt-in request as described above. Pursuant to block 504, the UpHabit application may be configured to display various introduction message templates. For example, as shown in FIG. 8, the UpHabit application may be configured to display the new introduction message screen 30 providing a plurality of templates 31 including templates for introduction messages to be sent by the UpHabit application. A user may select any one of the introduction message templates 31 in accordance with block 506, Flow proceeds to block 508, wherein the user composes and edits the introduction message.

The introduction message may automatically include a link to a social networking profile with the recipient contact's name (e.g., Linkedin, Facebook, Twitter, or other social media networks) for one or more contacts in the introduction message. This information may be linked with the contact's information in the UpHabit application.

Introduction message screen 30 may be configured to provide the user with the ability to create and reuse introduction templates, with placeholders for at least three fields of variable, Tillable information: contact name, respective introductory text, and respective LinkedIn profile or other links or social media accounts. The latter two are contact attributes that the user may optionally create for any contact. These placeholder fields are automatically filled in when the user selects the recipient to whom the email is going “To.”

The details of a contact's introductory text can be at the user's discretion, similar to the user's internal notes for a contact. Other sources of information for the introductory text besides the user's internal notes may be blocked for privacy and to prevent inadvertent disclosure, Introductions derived from a template can be further tailored by the user before being sent to the recipients via email.

The introduction message screen 30 may be configured to provide one or more saved message prompts, which may be formal or informal. A user may save introduction prompts to use again in the future. As described above, the user also may customize each introduction message.

The UpHabit application may be configured to give the user an option to send a survey to each of the introduction recipients after the introduction message is sent. For example, some of the introduction message templates may include a thumbs-up survey to be sent in due time after the introduction message is sent. If the introduction message template does not include a thumbs-up survey, then decision block 510 directs flow to block 512, whereby the introduction message is sent to the selected recipients. Although not shown, the UpHabit application may be configured to prompt the user to input a final confirmation before sending the introduction message. Because an optional survey was not included, no survey will be sent to the recipients, however the UpHabit application may be configured to allow the user to manually set a rating for the introduction in block 514 based on other feedback relating to the introduction. Finally, the user may mark the introduction as being complete in accordance with block 516.

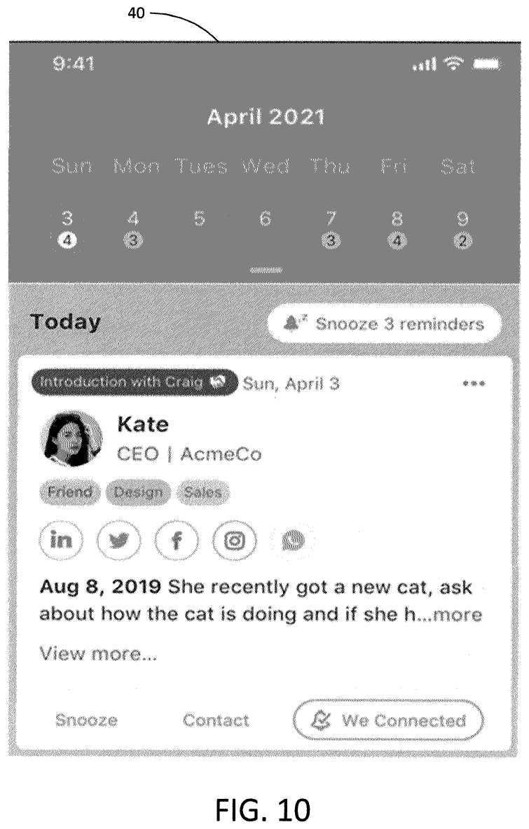

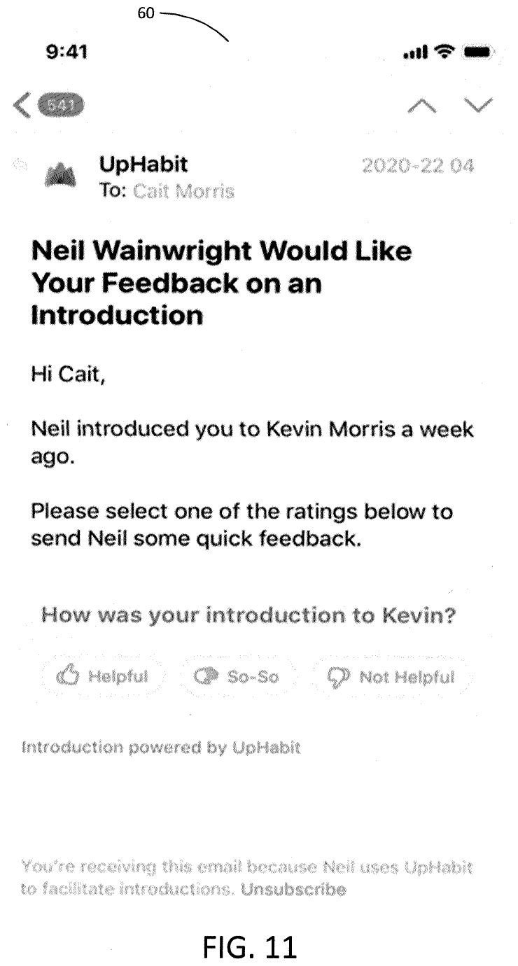

If the introduction message template does include a thumbs-up survey, then decision block 510 directs flow to block 518. Similar to the opt-in reminder scheduling, the UpHabit application may be configured to display reminder scheduling screen 40 shown in FIG. 10, whereby the user may input a desired period of time after the introduction message is sent before automatically sending the survey. Based on the user's input in block 520, the UpHabit application schedules the subsequent automatic sending of a survey to the introduction message recipients in accordance with block 522. The survey allows each of the introduction recipients to rate a value of the introduction. FIG. 11 shows an example of a survey screen 60 in accordance with an embodiment of the UpHabit application. While the flow diagram of FIG. 3 allows the user to schedule the survey prior to sending the introduction message, the UpHabit application may also be configured to allow the user to schedule a survey after the introduction message is sent, for example if the user originally elected a template without an included survey but later decides that a survey is desired.

Proceeding to block 524 in FIG. 3, the introduction message is sent to the selected recipients. Although not shown, the UpHabit application may be configured to prompt the user to input a final confirmation before sending the introduction message. Then, at the scheduled time, a survey is sent to each of the introduction recipients as indicated in block 526. As illustrated by decision block 528 and block 530, the UpHabit application may be configured such that as survey responses are received, the responses are used by the UpHabit application to automatically set an introduction rating for the introduction. At that point, the user may mark the introduction complete in accordance with block 516. If the introduction recipients fail to respond to the survey, the UpHabit application may be configured to allow the user to manually set an introduction rating in block 514 before marking the introduction complete in block 516.

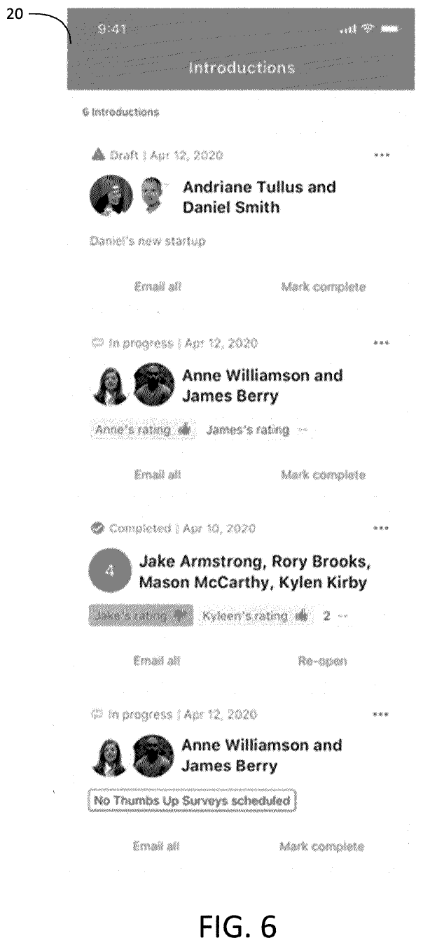

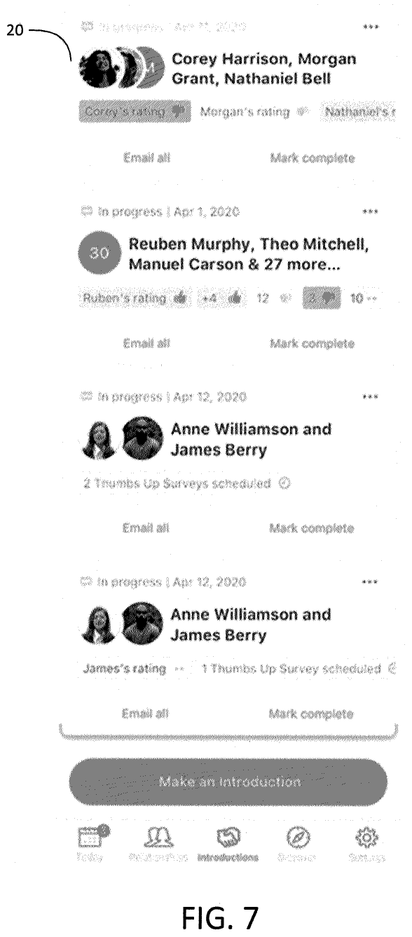

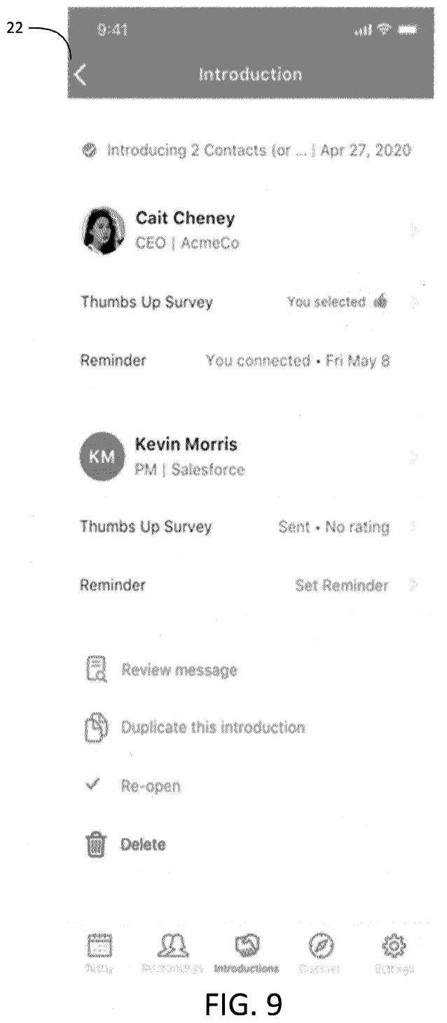

Introductions screen 20 may display the status of various introductions in the UpHabit application. For example, in the introduction screen 20 of FIG. 4, the Cait Chaney introduction is waiting on approval for an opt-in request. Also note that it identifies that James Berry has not rated the introduction to Anne Williamson. FIGS. 6 and 7 are other examples of introduction screens 20 summarizing the status of various introductions registered in the UpHabit application. The introductions screens allow a user to track introductions, see ratings, and determine if surveys are scheduled, among other things. The UpHabit application may be configured to display an introduction details screen 22, as illustrated by example in FIG. 9, providing further details regarding a specific introduction tapped by the user in the general introductions screen 20.

As will be appreciated, the UpHabit application of the present disclosure enhances and facilitates making introductions by applying multiple automation functions. These automated functions include: filling in contact names, introductory text, and Linkedin profiles or other social media profiles when using templates; duplicating and editing an introduction that was already made; requesting permission to make an introduction; and creating reminders to follow up and to request survey feedback. Integrated reminders allow the user to schedule one-time introduction reminders for each introduction recipient in order to follow up. The reminders may be linked to the respective introductions so that the user can retrieve introduction details from a reminder tab. Surveys allow the user to log and receive feedback on the value of an introduction by requesting multiple choice ratings from recipients, or the user may manually enter a rating on behalf of the recipients. The user can schedule the survey to be sent to the introduction recipients automatically via email a selected number of days after the introduction message is sent.

As described above, the UpHabit application is configured to create introductions and track or monitor those introductions created in the UpHabit application according to a first aspect of the present disclosure. In a second aspect of the present disclosure, the UpHabit application may be configured to execute a process for finding and tracking an introduction made by a user between or among two or more contacts wherein the introduction was made outside of the UpHabit application. With regard to the second aspect, and as generally illustrated in FIG. 1, the UpHabit application may be configured to scan the user's emails and display a suggested introduction made outside the UpHabit application for addition into the UpHabit application to facilitate tracking of the introduction. This functionality is represented by block 310 in FIG. 1. The UpHabit application may be configured to prompt the user for a decision pursuant to decision block 312 whether or not to add the suggested introduction to the UpHabit application. If the user decides to add the suggested introduction, decision block 312 directs flow to block 314, whereby the suggested introduction is added to the user's other introductions in the UpHabit application. Once the suggested introduction is added to the UpHabit application, it may be tracked and rated according to block 306, and marked complete according to block 308.

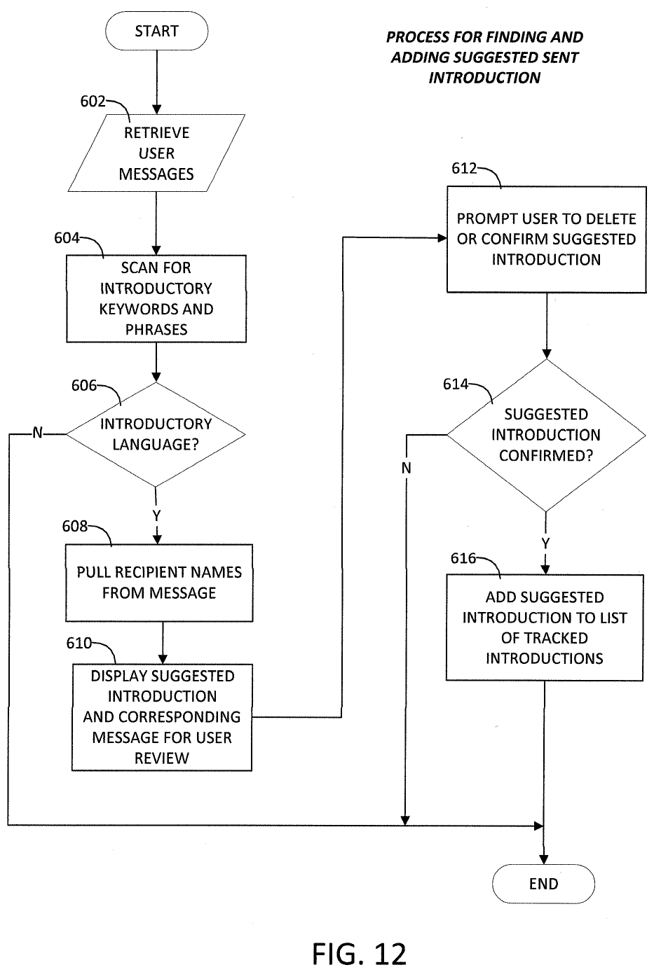

Reference is made to the flow diagram of FIG. 12 to describe the process for adding a suggested introduction to the UpHabit application. The UpHabit application may be configured to retrieve received and/or sent email messages from a user's inbox and/or sent items box, as indicated by block 602. Then, in block 604, the UpHabit application scans the messages for introductory keywords and phrases usually used in introductions. Examples of such keywords include “I would like to introduce you to,” “Would like to introduce you,” “Please meet,” “Want you to meet,” “Thanks for the introduction.” “It's great to meet you,” “I want you to meet,” or other similar phrases. Optionally, additional keywords can be manually added in a Settings tab in the UpHabit application to scan for more phrases. For example, a user can add common phrases the user typically uses when introducing two people (e.g., “I think you two should collaborate on” or “Always happy to introduce two of my friends”) or introductory phrases in Other languages. This ability may be available for any email client that the user has connected to the application, including, but not limited to, Galan, Yahoo, and Microsoft accounts.

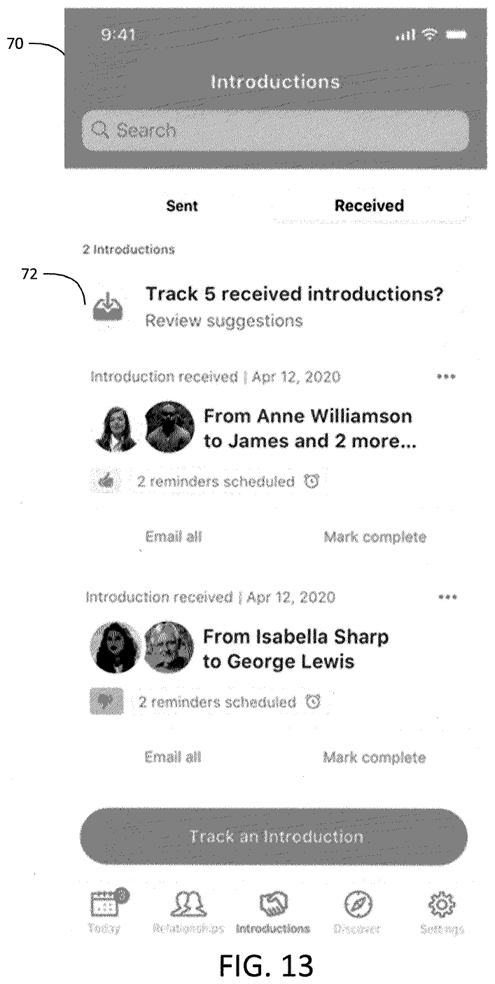

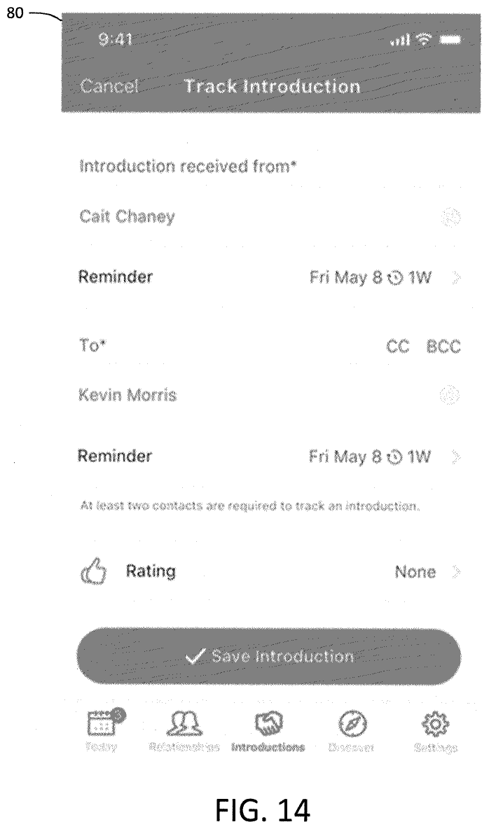

If the UpHabit application recognizes a keyword or phrase in one or more emails, then decision block 606 directs flow to block 608, wherein the UpHabit application is configured to pull the contact names from each email to suggest introductions to add to the UpHabit application. The UpHabit application may be configured to display a “Track received introductions?” card 72 in the introductions screen 70 as shown in FIG. 13, which allows a user to review suggested introductions as indicated in block 610. After the user activates the card 72, the user is able to review the suggested introductions. The details on this list include the above-mentioned contact names that are pulled from the corresponding email. The UpHabit application may be configured such that the user may tap a suggested introduction in the list to view the email message which was used to parse the suggested introduction data. Pursuant to block 612, the user may delete the suggested introduction, or confirm the introduction to be added to the UpHabit application and tracked. For example, the screen 80 shown in FIG. 14 allows the user to confirm that a suggested introduction is an introduction to be added to the UpHabit application, and to set a reminder or survey for the added introduction. If the user confirms the suggested introduction, decision block 614 directs flow to block 616 wherein the UpHabit application is configured to add the suggested introduction to the user's introductions as a “received introduction” to be tracked by the UpHabit application.

Parsing the data and displaying this data in the user interface screens in an accurate manner that resembles the details of the introduction made via email is an advantage of the UpHabit application of the present disclosure over previous systems. Names and introductory phrases are not always located in the same place in an email or across different email inboxes, in an embodiment, the names are pulled from the email for display on the screen of the application. For example, the UpHabit application may be configured to apply parsing algorithms to the content of the email to identify strings of characters from the email content that potentially match contact names, introductory phases and other data. For example, the parsing algorithm may include a RegEx function that is configured to define an expression that defines the keyword of interest and to look for match results from a character string of inputs in the email content. In one instance, a function may be designed to return undefined elements of an input string by returning the remainder of the input string that was not defined as a RegEx expression. For example, an email address can be the input string, the typical contents of an email address can be defined as a RegEx expression and the undefined remainder of the email address, which may be the user name, may be returned. The subject line of the email can be added as a note for the introduction. A link to the email also may be included in the UpHabit application.

The UpHabit application may be configured to give the user the option to send a survey to each of the introduction contacts after the tracking is activated. The survey allows each of the introduction contacts to rate a value of the introduction. A user may schedule the survey after the tracking is activated. For example, the user can set a time period for the survey to be sent after the introduction message is sent. The application can automatically send the survey at the designated time after the tracking of the added introduction is activated. Surveys allow the user to log and receive feedback on the value of an introduction by requesting multiple choice ratings from recipients, or by manually entering a rating on behalf of the recipients. The user can schedule the survey to be sent a variable number of days after the tracking is activated.

Integrated reminders allow the user to schedule one-time introduction reminders for each introduction recipient in order to follow up. The reminders can be linked to the introductions so that the user can retrieve introduction details from a reminder card.

The UpHabit application may be configured such that if an introductory term or phrase is detected in an email with a new contact not in the user's contact list, the UpHabit application may add that contact to the contact list in the UpHabit application either automatically or upon receiving confirmation from the user.

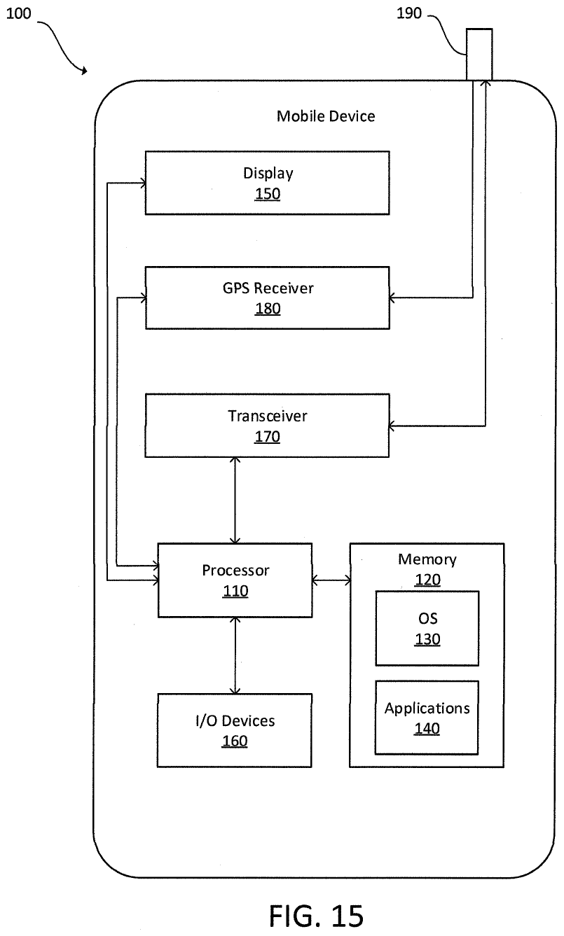

FIG. 15 is a block diagram illustrating the mobile device 100, according to an example embodiment. The mobile device may correspond to, for example, one or more client machines or application servers. One or more embodiments of the method described herein may be implemented on or executed by the mobile device 100. The mobile device 100 may include a processor 110. The processor 110 may be any of a variety of different types of commercially available processors suitable for mobile devices (for example, an XScale architecture microprocessor, a Microprocessor without Interlocked Pipeline Stages (MIPS) architecture processor, or another type of processor). A memory 120, such as a Random Access Memory (RAM), a Flash memory, or other type of memory, is typically accessible to the processor 110. The memory 120 may be adapted to store an operating system (OS) 130, as well as application programs 140, such as a mobile location enabled application that may provide location based services to a user. The processor 110 may be coupled, either directly or via appropriate intermediary hardware, to a display 150 and to one or more input/output (I/O) devices 160, such as a keypad, a touch panel sensor, a microphone, and the like. Similarly, in some embodiments, the processor 110 may be coupled to a transceiver 170 that interfaces with an antenna 190. The transceiver 170 may be configured to both transmit and receive cellular network signals, wireless data signals, or other types of signals via the antenna 190, depending on the nature of the mobile device 100. Further, in some configurations, a GPS receiver 180 may also make use of the antenna 190 to receive OPS signals.

Certain embodiments are described herein as including logic or may operate using one or more components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Accordingly, software may configure a processor to constitute, for example, a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed, among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product (e.g., a computer program) tangibly embodied in an information carrier (e.g., in a machine-readable medium) for execution by, or to control the operation of, data processing apparatus (e.g., a programmable processor, a computer, or multiple computers).

A computer program can be written in any form of programming language, including compiled or interpreted languages, and it can be deployed in any form, including as a standalone program or as a module, subroutine, or other unit suitable for use in a computing environment. A computer program can be custom-developed for a particular hardware, in its dedicated software development environment. As a non-limiting example, an Android application program can be developed for a hardware running an Android OS and an IOS application program can be developed for a hardware running an IOS and so on. A computer-software-user-interface can be custom-developed for a particular hardware, in its dedicated software development environment, A computer program may partially include a web based software language, A computer program may also include native software languages and in some instances, may be built entirely with native software languages, A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, such as a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Embodiments disclosed herein can store or access information on the client or the server.

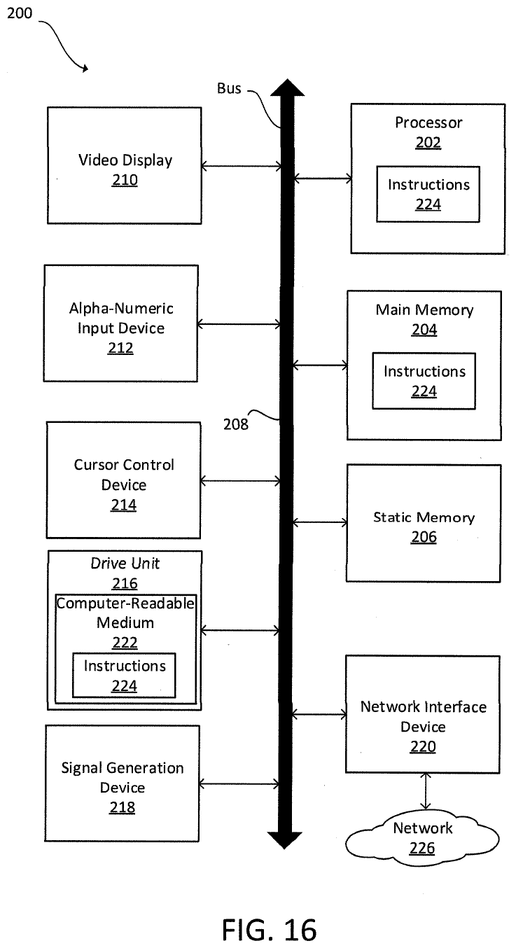

FIG. 16 is a block diagram of a machine in the example form of a computer system 200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a settop box (SIB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 200 includes a processor 202 (e.g., a central processing unit (CPU), a graphics processing unit (GPU), or both), a main memory 204, and a static memory 206, which communicate with each other via a bus 208. The computer system 200 may further include a video display unit 210 (e.g., a liquid crystal display (LCD) or a cathode ray tube (CRT)). The computer system 200 also includes an alphanumeric input device 212 (e.g., a keyboard or a touch-sensitive display screen), a user interface (UI) navigation device 214 (e.g., a mouse), a disk drive unit 216, a signal generation device 218 (e.g., a speaker), and a network interface device 220.

The disk drive unit 216 includes a machine-readable medium 222 on which is stored one or more sets of instructions and data structures (e.g., software) 224 embodying or utilized by any one or more of the methodologies or functions described herein. The instructions 224 may also reside, completely or at least partially, within the main memory 204 and/or within the processor 202 during execution thereof by the computer system 200, the main memory 204 and the processor 202 also constituting machine-readable media.

While the machine-readable medium 222 is shown in an example embodiment to be a single medium, the term “machine-readable medium” may include a single medium or multiple media (e.g., a centralized or distributed database and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, optical, and magnetic media, Specific examples of machine-readable media include non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto optical disks; and CD-ROM and DVD-ROM disks.

The instructions 224 may further be transmitted or received over a communications network 226 using a transmission medium. The instructions 224 may be transmitted using the network interface device 220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., LTE, and WiMAX networks), The term “transmission medium” shall be taken to include any intangible medium that is capable of storing, encoding or carrying instructions for execution by the machine, and includes digital or analog communications signals or other intangible media to facilitate communication of such software.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
receiving, using a processor, a plurality of contacts selected for a proposed introduction;
displaying an introduction message screen, using the processor, wherein the introduction message screen is configured for composing an introduction message to be sent to the plurality of contacts to make the introduction, wherein the introduction message screen includes finable fields for each of the plurality of contacts and a message text field, wherein the fillable fields are filled using the processor, and the message text field receives text entries entered by a user; and
sending an introduction message, using the processor, to the plurality of contacts, wherein the message includes inputs to the fillable fields and text entered in the message text field.

2. The method of claim 1, further comprising sending, using the processor, an opt-in request to at least one of the plurality of contacts prior to sending the introduction message, wherein the introduction message is only sent if each contact receiving the opt-in request approves the proposed introduction.

3. The method of claim 2, wherein the opt-in request is sent to each of the plurality of contacts,

4. The method of claim 1, wherein the introduction message automatically includes a link to a social networking profile for at least one of the contacts.

5. The method of claim 1, wherein each of the plurality of contacts is in a contact list in a database of the user.

6. The method of claim 5, wherein the database includes a link to a social networking profile for the two contacts.

7. The method of claim 1, further comprising sending, using the processor, a survey to each of the plurality of contacts after the introduction message is sent, wherein the survey allows each of the plurality of contacts to rate a value of the introduction.

8. The method of claim 7, further comprising receiving scheduling data indicating a scheduled time the survey is to be sent after the introduction message is sent, and automatically sending the survey, using the processor, at the scheduled time.

9. The method of claim 1, further comprising:
scanning emails of the user, using the processor, to find introductory terms and phrases;
displaying, using the processor, a suggested introduction screen based on the scanning, wherein the suggested introduction screen lists a suggested introduction corresponding to an email containing an introductory term or phrase;
receiving a confirmation that the suggested introduction represents an actual introduction to be tracked; and
adding, using the processor, the suggested introduction to a set of tracked introductions.

10. The method of claim 9, further comprising sending, using the processor, a survey to each recipient of the email other than the user, wherein the survey allows each of the two contacts to rate a value of the introduction.

11. The method of claim 10, further comprising scheduling the survey using the processor after the adding.

12. A system configured to use the method of claim 1.

13. The system of claim 12, wherein the system is a mobile device.

14. A non-transitory computer readable medium storing a program configured to instruct a processor to execute the method of claim 1.

15. A method comprising:
scanning emails of a user, using a processor, to find introductory terms and phrases;
determining, using the processor, that one of the emails is a potential introduction email based on introductory phrases; and
displaying, using the processor, a screen to the user prompting the user to confirm that the potential introduction email is an actual introduction email.

16. The method of claim 15, wherein the introductory phrases indicate that the user introduced a plurality of contacts to each other.

17. The method of claim 15, further comprising adding, using the processor, the potential introduction email to a list of introductions by the user if the user confirms the potential introduction email is an actual introduction email.

18. The method of claim 15, wherein the introductory phrases are saved in a list accessed by the processor.

19. A system configured to execute the method of claim 15.

20. The system of claim 19, wherein the system is a mobile device.

21. A non-transitory computer readable medium storing a program configured to instruct a processor to execute the method of claim 15.
